(19) United States
(12) Patent Application Publication
(10) Pub. No.: US 2025/0375638 A1
(43) Pub. Date: Dec. 11, 2025

(54) FIRE EXTINGUISHING STRUCTURE, BATTERY PACK INCLUDING THE SAME, AND METHOD OF MANUFACTURING FIRE EXTINGUISHING STRUCTURE

(71) Applicant: SAMSUNG SDI CO., LTD., Yongin-si (KR)

(72) Inventor: Sanghun PARK, Yongin-si (KR)

(21) Appl. No.: 19/006,697

(22) Filed: Dec. 31, 2024

(30) Foreign Application Priority Data
Jun. 7, 2024 (KR) 10-2024-0074471

(51) Int. Cl. A62C 3/16; A62C 37/11; H01M 50/213; H01M 50/682

(52) U.S. Cl. CPC A62C 3/16; A62C 37/11; H01M 50/213; H01M 50/682

(57) ABSTRACT

A fire extinguishing structure on a plurality of battery cells, the fire extinguishing structure configured to extinguish a fire when the fire occurs in at least one of the plurality of battery cells, the fire extinguishing structure including a plurality of first support members, a plurality of second support members cross-fastened to the plurality of first support members, the plurality of first support members and the plurality of second support members together defining a lattice structure, and a fire extinguishing patch included on at least one of the plurality of first support members or the plurality of second support members.

### CROSS-REFERENCE TO RELATED APPLICATION

The present application claims priority to and the benefit of Korean Patent Application No. 10-2024-0074471, filed on June 7, 2024, in the Korean Intellectual Property Office, the entire disclosure of which is incorporated herein by reference.

### BACKGROUND

### 1. Field

Embodiments relate to a fire extinguishing structure, a battery pack including the same, a method of manufacturing the fire extinguishing structure.

### 2. Description of the Related Art

Unlike primary batteries that are not designed to be charged, secondary batteries are designed to be repeatedly discharged and recharged. Low-capacity secondary batteries are used in small portable electronic devices, such as smart phones, feature phones, notebook computers, digital cameras, and camcorders, while large-capacity secondary batteries are widely used as power sources for driving motors, such as of hybrid vehicles or electric vehicles, and for power storage. A secondary battery includes an electrode assembly including a positive electrode and a negative electrode, a case that accommodates the electrode assembly, a terminal part connected to the electrode assembly, etc.

If a temperature of a secondary battery rises due to thermal or electrical and physical impacts applied to the battery including a positive electrode material, a negative electrode material, a separator, an electrolyte, etc., a short-circuit may occur in the battery as the separator is decomposed. Accordingly, a “thermal runaway phenomenon” may occur in which when a fire occurs in the battery, an internal temperature of the battery rises 1000° C. or higher in an instant and the fire is spread. As a result, there is a problem in that it is difficult to extinguish the fire as all of thermal and electrochemical energy that is left in the battery is discharged to the surroundings because the stability of the battery is lost.

The above information disclosed in this Background section is for enhancement of understanding of the background of the present disclosure, and therefore, it may contain information that does not constitute related (or prior) art.

### SUMMARY

Embodiments include a fire extinguishing structure on a plurality of battery cells, the fire extinguishing structure configured to extinguish a fire when the fire occurs in at least one of the plurality of battery cells, the fire extinguishing structure including a plurality of first support members, a plurality of second support members cross-fastened to the plurality of first support members, the plurality of first support members and the plurality of second support members together defining a lattice structure, and a fire extinguishing patch included on at least one of the plurality of first support members or the plurality of second support members.

Each of the plurality of first support members may include first fastening grooves at predetermined intervals and configured to fasten each of the plurality of second support members.

Each of the plurality of second support members may include second fastening grooves at predetermined intervals and configured to fasten each of the plurality of first support members.

Each of the plurality of first support members may include a first bending support part, each first bending support part being a folded portion of each of the plurality of first support members so that a side thereof is supported.

Each of the plurality of second support members may include a second bending support part, each second bending support part being a folded portion of each of the plurality of second support members so that a side thereof is supported.

The first bending support part and the second bending support part support the side of each of the plurality of second support members and the side of each of the plurality of first support members, respectively, wherein the first bending support part and the second bending support part face each other.

Each of the plurality of first support members may include a first bending shape retention part, each first bending retention part being a folded portion of each of the plurality of first support members in a length direction thereof so that a shape of each of the plurality of first support members is retained.

Each of the plurality of second support members may include a second bending shape retention part, each second bending retention part being a folded portion of each of the plurality of second support members in a length direction thereof so that a shape of each of the plurality of second support members is retained.

Embodiments include a battery pack, the battery pack including a plurality of battery cells, and a fire extinguishing structure on the plurality of battery cells, the fire extinguishing structure configured to extinguish a fire when the fire occurs in at least one of the plurality of battery cells, wherein the fire extinguishing structure includes a plurality of first support members and a plurality of second support members cross-fastened to the plurality of first support members, the plurality of first support members and the plurality of second support members together defining a lattice structure, and a fire extinguishing patch included in at least one of the plurality of first support members or the plurality of second support members.

Each of the plurality of first support members may include first fastening grooves at predetermined intervals and configured to fasten the plurality of second support members.

Each of the plurality of second support members may include second fastening grooves at predetermined intervals and configured to fasten the plurality of first support members.

Each of the plurality of first support members may include a first bending support part, each first bending support part being a folded portion of each of the plurality of first support members so that a side thereof is supported.

Each of the plurality of second support members may include a second bending support part, each second bending support part being a folded portion of each of the plurality of second support members so that a side thereof is supported.

The first bending support part and the second bending support part may support the side of each of the plurality of second support members and the side of each of the plurality of first support members, respectively, wherein the first bending support part and the second bending support part may face each other.

Each of the plurality of first support members may include a first bending shape retention part, each first bending shape retention part being a folded portion of each of the plurality of first support members in a length direction thereof so that a shape of each of the plurality of first support members is retained.

Each of the plurality of second support members may include a second bending shape retention part, each second bending shape retention part being a folded portion of each of the plurality of second support members in a length direction thereof so that a shape of each of the plurality of second support members is retained.

Embodiments include a method of manufacturing a fire extinguishing structure on a plurality of battery cells and configured to extinguish a fire when the fire occurs in at least one of the plurality of battery cells, the method including manufacturing a plurality of first support members, manufacturing a plurality of second support members, and forming a lattice structure by cross-fastening the plurality of first support members and the plurality of second support members.

The manufacturing of the plurality of first support members may include forming first fastening grooves having predetermined intervals and configured to fasten the plurality of second support members, and the manufacturing of the plurality of second support members may include second fastening grooves having predetermined intervals and configured to fasten the plurality of first support members.

The manufacturing of the plurality of first support members may include forming a first bending support part by folding a part of each of the plurality of first support members so that a side thereof is supported, and the manufacturing of the plurality of second support members may include forming a second bending support part by folding a part of each of the plurality of second support members so that a side thereof is supported.

The manufacturing of the plurality of first support members may include forming a first bending shape retention part by folding each of the plurality of first support members in a length direction thereof so that a shape of each of the plurality of first support members is retained, and the manufacturing of the plurality of second support members may include forming a second bending shape retention part by folding each of the plurality of second support members in a length direction thereof so that a shape of each of the plurality of second support members is retained.

However, aspects and features of the present disclosure are not limited to those described above, and other aspects and features not mentioned will be clearly understood by a person of ordinary skill in the art from the detailed description, described below.

### BRIEF DESCRIPTION OF THE DRAWINGS

Features will become apparent to those of ordinary skill in the art by describing in detail exemplary embodiments with reference to the attached drawings, in which:

FIG. 1A is an upper perspective view of a cylindrical secondary battery according to one or more embodiments;

FIG. 1B is a cross-sectional view of the cylindrical secondary battery of FIG. 1A;

FIG. 2A is an upper perspective view of a prismatic secondary battery according to one or more embodiments;

FIG. 2B is a cross-sectional view taken along line I-I′ of FIG. 2A.

FIG. 3 is a diagram illustrating an example in which a fire extinguishing structure according to one or more embodiments of the present disclosure has been applied;

FIG. 4 is a perspective view of a fire extinguishing structure according to one or more embodiments of the present disclosure;

FIG. 5 is a diagram illustrating a first support member of the fire extinguishing structure according to one or more embodiments of the present disclosure;

FIG. 6 is a perspective view of a coupling structure of a fire extinguishing structure according to one or more embodiments of the present disclosure;

FIG. 7 is a plan view illustrating the coupling structure of a fire extinguishing structure according to one or more embodiments of the present disclosure;

FIG. 8 is a side view illustrating a coupling structure of a fire extinguishing structure according to one or more embodiments of the present disclosure; and

FIG. 9 is a flowchart for describing a method of manufacturing a fire extinguishing structure according to embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those of ordinary skill in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

It will be understood that if an element or layer is referred to as being “on,” “connected to,” or “coupled to” another element or layer, it may be directly on, connected, or coupled to the other element or layer or one or more intervening elements or layers may also be present. If an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. If phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

Throughout the specification, if “A and/or B” is stated, it means A, B or A and B, unless otherwise stated. That is, “and/or” includes any or all combinations of a plurality of items enumerated. If “C to D” is stated, it means C or more and D or less, unless otherwise specified.

The terminology used herein is for the purpose of describing embodiments of the present disclosure and is not intended to limit the present disclosure.

The type of secondary battery includes a coin type, a cylindrical type, a prismatic type, and a pouch type. Prior to a description of embodiments of the present disclosure, first, cylindrical and prismatic secondary batteries are roughly described because the present disclosure may be basically applied to the cylindrical and prismatic secondary batteries.

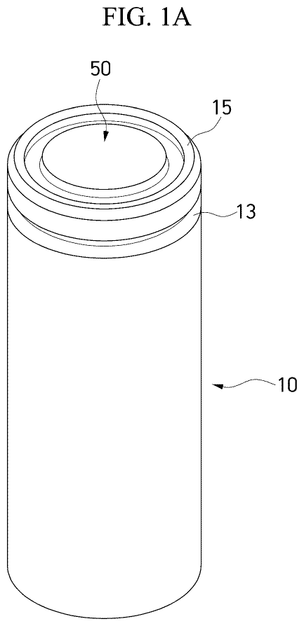

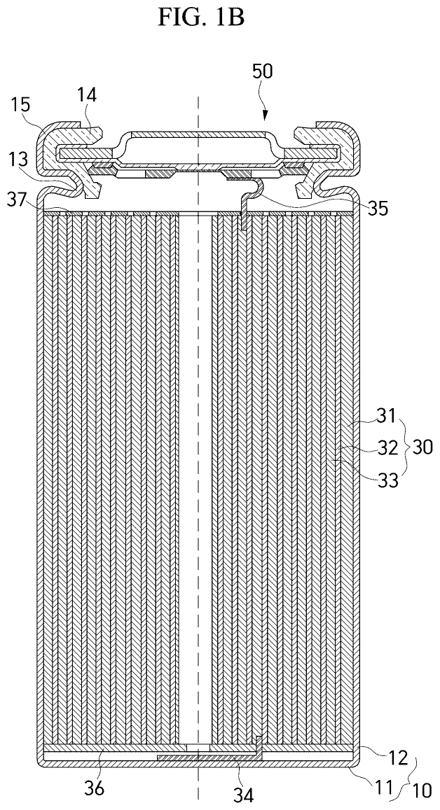

FIG. 1A is an upper perspective view of a cylindrical secondary battery according to one or more embodiments of the present disclosure. FIG. 1B is a cross-sectional view of the cylindrical secondary battery of FIG. 1A.

Referring to FIG. 1A and FIG. 1B, the cylindrical secondary battery may include an electrode assembly 30, a case 10 that accommodates the electrode assembly 30 and an electrolyte therein, a cap assembly 50 that is connected to an opening of the case 10 and that seals the case 10, and an insulating plate 37 disposed between the electrode assembly 30 and the cap assembly 50 within the case 10.

The electrode assembly 30 may include a separator 32, a first electrode 33 and a second electrode 31 with the separator 32 interposed between, and may be wound in a jelly-roll form.

The first electrode 33 may include a first base and a first active material layer disposed in the first base. A first lead tap 35 may extend from a first uncoated part that belongs to the first base and in which the first active material layer is not disposed to the outside. The first lead tap 35 may be electrically connected to the cap assembly 50.

The second electrode 31 may include a second base and a second active material layer disposed in the second base. A second lead tap 34 may extend from a second uncoated part that belongs to the second base and in which the second active material layer is not disposed to the outside. The second lead tap 34 may be electrically connected to the case 10. The first lead tap 35 and the second lead tap 34 may extend in opposite directions.

The first electrode 33 may function as a positive electrode. In this case, the first base may be composed of aluminum foil, for example. The first active material layer may include transition metal oxide, for example. The second electrode 31 may function as a negative electrode. In this case, the second base may be composed of copper foil or nickel foil, for example. The second active material layer may include graphite, for example.

The separator 32 functions to permit a movement of lithium ions and to prevent the short-circuit of the first electrode 33 and the second electrode 31. The separator 32 may be composed of a polyethylene film, a polypropylene film, or a polyethylene-polypropylene film, for example. The case 10 may accommodate the electrode assembly 30 and an electrolyte, and forms an external form of the battery along with the cap assembly 50. The case 10 may include a body part 12 having an approximate cylindrical shape and a bottom part 11 connected to one side of the body part 12. A beading part 13 that has been deformed toward the inside of the body part 12 may be disposed in the body part 12. A crimping part 15 that has been bent toward the inside of the body part 12 may be disposed at an end of the body part 12 on the opening side.

The beading part 13 may suppress a movement of the electrode assembly 30 within the case 10, and may facilitate the settlement of a gasket 14 and the cap assembly 50. The crimping part 15 may firmly fix the cap assembly 50 by pressurizing an edge of the cap assembly 50 through the gasket 14. The case 10 may be made of iron plated with nickel, for example.

The cap assembly 50 may seal the case 10 by being fixed to the inside of the crimping part 15 through the gasket 14. The cap assembly 50 may include a cap-up part, a safety vent, a cap-down part, an insulating member, and a sub-plate, but the present disclosure is not limited to such examples. The cap assembly 50 may be variously deformed.

The cap-up part may be disposed at the top of the cap assembly 50. The cap-up part may include a terminal part that convexly protrudes upward (as oriented in FIGS. 1A and 1B) and that is connected to an external circuit. An output for discharging a gas around the terminal part may be disposed in the cap-up part.

The safety vent may be disposed under the cap-up part. The safety vent may include a protruding part that convexly protrudes downward and that is connected to the sub-plate, and at least one notch disposed around the protruding part.

When a gas is generated due to over-charging or an abnormal operation of the secondary battery, the protruding part may be upwardly deformed by the pressure of the gas and separated from the sub-plate. Furthermore, the safety vent may be cut along the notch. The cut safety vent can prevent the explosion of the secondary battery by discharging the gas to the outside.

The cap-down part may be disposed under the safety vent. A first opening for exposing the protruding part of the safety vent and a second opening for discharging a gas may be disposed in the cap-down part. The insulating member may be disposed between the safety vent and the cap-down part, and may insulate the safety vent and the cap-down part.

The sub-plate may be disposed under the cap-down part. The sub-plate may be fixed to the bottom of the cap-down part in order to close the first opening of the cap-down part. The protruding part of the safety vent may be fixed to the sub-plate. The first lead tap 35 that has been withdrawn from the electrode assembly 30 may be fixed to the sub-plate. Accordingly, the cap-up part, the safety vent, the cap-down part, and the sub-plate may be electrically connected to the first electrode 33 of the electrode assembly 30.

The insulating plate 37 may adjoin the electrode assembly 30 under the beading part 13. A tap opening for withdrawing the first lead tap 35 may be provided in the insulating plate 37. The cap assembly 50 that has been electrically connected to the first electrode 33 by the first lead tap 35 may face the electrode assembly 30 with the insulating plate 37 interposed therebetween. The cap assembly 50 may maintain the state in which the cap assembly 50 has been insulated from the electrode assembly 30 by the insulating plate 37. The cylindrical secondary battery may include another insulating plate 36 for insulation between the electrode assembly 30 and the bottom part 11 of the case 10.

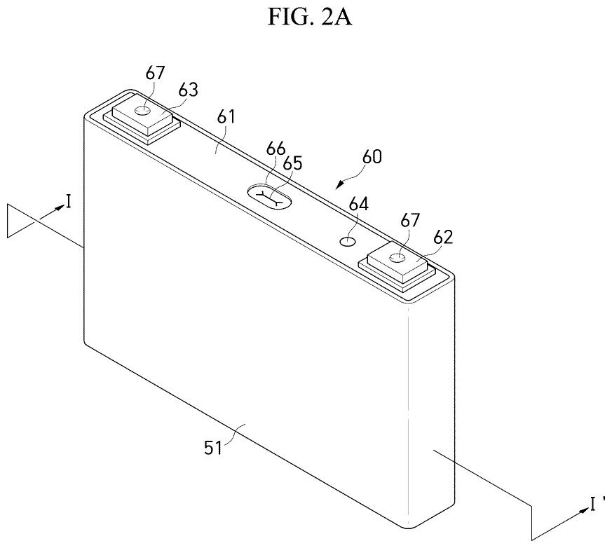

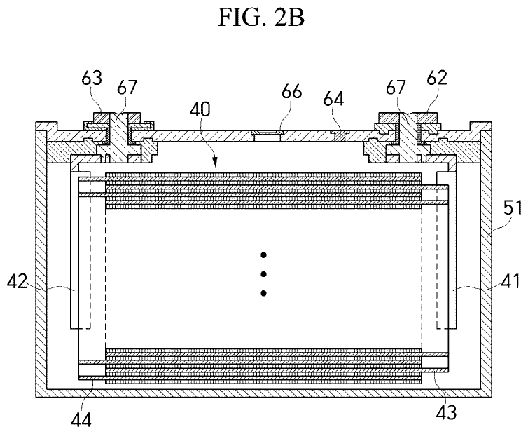

FIG. 2A is a top perspective view of a prismatic secondary battery according to one or more embodiments of the present disclosure. FIG. 2B is a cross-sectional view taken along the line I-I′ of FIG. 2A.

First, the external appearance of the prismatic secondary battery illustrated in FIG. 2A will be described.

A case 51 defines an overall appearance of the prismatic secondary battery, and may be made of a conductive metal, such as aluminum, aluminum alloy, or nickel-plated steel. In addition, the case 51 may provide a space for accommodating an electrode assembly therein.

A cap assembly 60 may include a cap plate 61 that covers the opening of the case 51. In some examples, the case 51 and the cap plate 61 may be made of a conductive material. Here, a first terminal 62 and a second terminal 63 may be electrically connected to respective positive and negative (or negative and positive) electrodes inside the case, and may be installed to protrude outward through the cap plate 61.

The cap plate 61 may be equipped with an electrolyte injection port 64 formed to install a sealing plug (or seal pin), and a vent 66 formed with a notch 65. The vent 66 is for discharging gas generated inside the secondary battery.

With reference to FIG. 2B, the internal structure of the prismatic secondary battery and the coupling structure with the cap assembly 60 will be further described.

As shown in FIG. 2B, a prismatic secondary battery may include an electrode assembly 40, a first current collector 41, a first terminal 62, a second current collector 42, a second terminal 63, a case 51, and a cap assembly 60.

An electrode assembly 40 may be formed by winding or stacking a stack of a first electrode plate, a separator, and a second electrode plate, which are formed as thin plates or films. If the electrode assembly 40 is a wound stack, a winding axis may be parallel to the longitudinal direction (e.g., the y direction) of the case 51, as oriented in FIGS. 2A and 2B. In some other embodiments, the electrode assembly 40 is a stack type rather than a winding type, and the shape of the electrode assembly 40 is not limited in the present disclosure. In addition, the electrode assembly 40 may be a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case, and the number of electrode assemblies in the case is not limited in the present disclosure. The first electrode plate of the electrode assembly may act as a negative electrode, and the second electrode plate may act as a positive electrode. Of course, the reverse is also possible.

The first electrode plate may be formed by applying a first electrode active material, such as graphite, carbon, or the like, to a first electrode current collector formed of a metal foil, such as copper, a copper alloy, nickel, a nickel alloy, or the like. The first electrode plate may include a first electrode tab 43 (e.g., a first uncoated portion) that is a region to which the first electrode active material is not applied. The first electrode tab 43 may act as a current flow path between the first electrode plate and the first current collector 41. In some embodiments, at the time the first electrode plate is manufactured, the first electrode tab 43 is formed by being cut in advance to protrude to one side of the electrode assembly 40, or the first electrode tab 43 may protrude to one side of the electrode assembly 40 more than (e.g., farther than or beyond) the separator without being separately cut.

The second electrode plate may be formed by applying a second electrode active material, such as a transition metal oxide, on a second electrode current collector formed of a metal foil, such as aluminum or an aluminum alloy. The second electrode plate may include a second electrode tab 44 (e.g., a second uncoated portion) that is a region to which the second electrode active material is not applied. The second electrode tab 44 may act as a current flow path between the second electrode plate and the second current collector 42. In some embodiments, the second electrode tab 44 may be formed by being cut in advance to protrude to the other side (e.g., the opposite side) of the electrode assembly when the second electrode plate is manufactured, or the second electrode plate may protrude to the other side of the electrode assembly more than (e.g., farther than or beyond) the separator without being separately cut.

In some embodiments, the first electrode tab 43 may be located on the left side of the electrode assembly 40, and the second electrode tab 44 may be located on the right side of the electrode assembly 40. In other embodiments, the first electrode tab 43 and the second electrode tab 44 may be located on one side of the electrode assembly 40 in the same direction. Here, for convenience of description, the left and right sides are defined according to the secondary battery as oriented in FIG. 1, and the positions thereof may change when the secondary battery is rotated left and right or up and down.

The separator prevents or substantially reduces instances of a short circuit between the first electrode and the second electrode while allowing movement of lithium ions therebetween. The separator may be made of, for example, a polyethylene film, a polypropylene film, a polyethylene-polypropylene film, or the like.

The first electrode tab 43 of the first electrode plate and the second electrode tab 44 of the second electrode plate may be positioned at both ends (e.g., opposite ends) of the electrode assembly 40. In some embodiments, the electrode assembly 40 is accommodated in the case 10 along with an electrolyte.

In addition, in the electrode assembly 40, the first current collector 41 and the second current collector 42 may be welded and connected to the first electrode tab 43 of the first electrode plate and the second electrode tab 44 of the second electrode plate exposed on both sides, respectively, to then be positioned thereat, respectively.

The first current collector 41 and the second current collector 42 may be connected to the first terminal 62 and the second terminal 63 described with reference to FIG. 2A, through terminal pins 67, respectively. In some embodiments, outer circumference surfaces of the terminal pins 67 may be subjected to screw processing, and may be fastened to the first terminal 62 and the second terminal 63, respectively, through screw coupling. However, the present disclosure is not limited to such an example, and the terminal pins 67 may be connected to the first terminal 62 and the second terminal 63 in a riveting way or by welding.

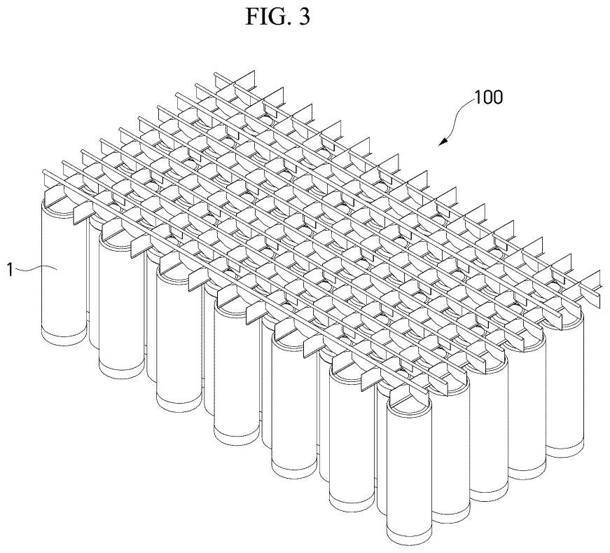

FIG. 3 is a diagram illustrating an example in which a fire extinguishing structure according to one or more embodiments of the present disclosure has been applied.

Referring to FIG. 3, a fire extinguishing structure 100 according to embodiments of the present disclosure may be disposed on a plurality of battery cells 1, and can extinguish a fire when the fire occurs in some of the plurality of battery cells 1. In some embodiments, the battery cell may be a circular secondary battery cell. When a fire occurs in some of the plurality of battery cells 1, a fire extinguishing patch included in the fire extinguishing structure 100 can extinguish the fire by using a fire extinguishing medium that is secreted from the fire extinguishing patch, by responding to heat attributable to the fire.

In one or more embodiments, the fire extinguishing structure 100 and the battery cell 1 may form a battery pack by being inserted into a case (not illustrated) in a form illustrated in FIG. 3.

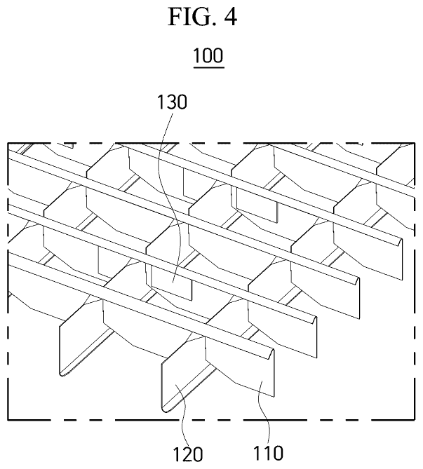

Hereinafter, a structure of the fire extinguishing structure 100 according to one or more embodiments of the present disclosure is described with reference to FIGS. 4 to 8.

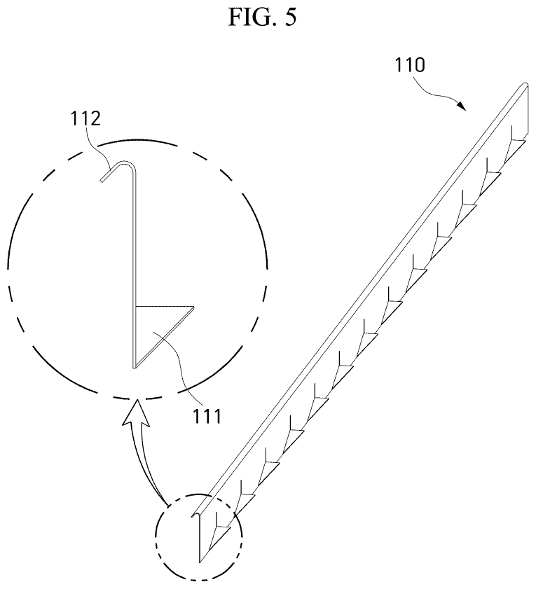

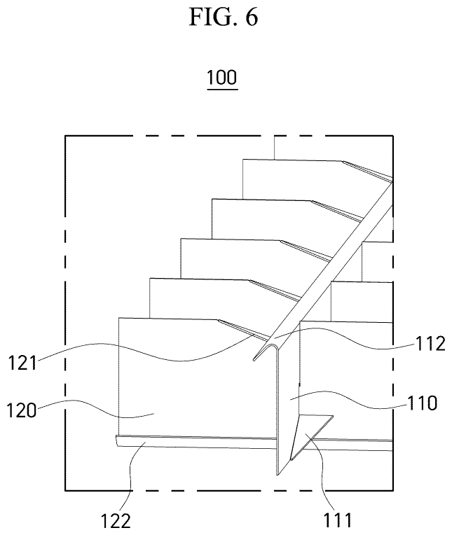

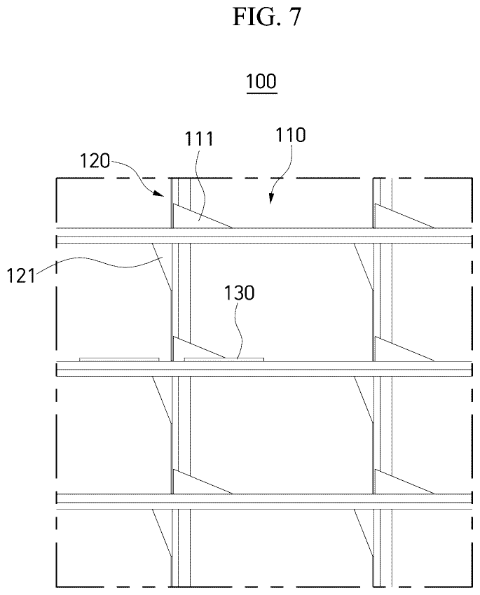

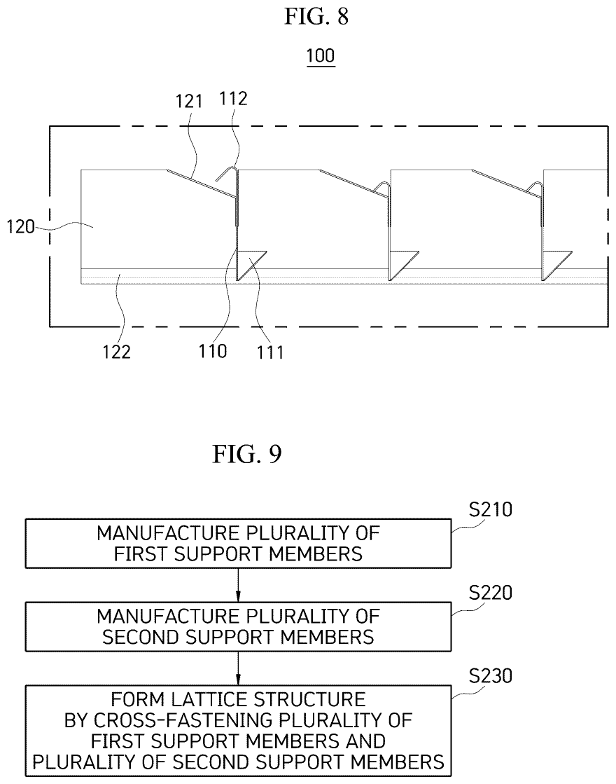

FIG. 4 is a perspective view of a fire extinguishing structure according to one or more embodiments of the present disclosure. FIG. 5 is a diagram illustrating a first support member of a fire extinguishing structure according to one or more embodiments of the present disclosure. FIG. 6 is a perspective view of a coupling structure of a fire extinguishing structure according to one or more embodiments of the present disclosure. FIG. 7 is a plan view illustrating the coupling structure of a fire extinguishing structure according to one or more embodiments of the present disclosure. FIG. 8 is a side view illustrating a coupling structure of a fire extinguishing structure according to one or more embodiments of the present disclosure.

Referring to FIGS. 4 to 8, the fire extinguishing structure 100 according to one or more embodiments of the present disclosure may include a first support member 110, a second support member 120, and a fire extinguishing patch 130.

The first support member 110 and the second support member 120 may each be provided in a plural number. The plurality of first support members 110 and the plurality of second support members 120 may be cross-fastened to form a lattice structure. In one or more embodiments, an intersecting point of the first support member 110 and the second support member 120 may be formed at the top of each battery cell 1 so that a fire can be effectively extinguished when the fire occurs.

In one or more embodiments, release paper that is used to manufacture the fire extinguishing patch 130 may be used in the first support member 110 and the second support member 120. The release paper may be paper that is attached to the rear of the fire extinguishing patch in order to protect an adhesive surface of the fire extinguishing patch. In general, the release paper is discarded after the fire extinguishing patch 130 is stripped off. The fire extinguishing structure 100 according to one or more embodiments of the present disclosure can reduce waste and reduce a cost for manufacturing a battery pack because the release paper, an inexpensive material, is used in the first support member 110 and the second support member 120. In one or more embodiments, the release paper may be used for the materials of the first support member 110 and the second support member 120. The materials of the first support member 110 and the second support member 120 may be polymer resin, such as polyethylene (PE), polypropylene (PP), polyvinyl chloride (PVC), polystyrene (CPS), polyethylene terephthalate (PETE), polycarbonate (PC), or polyacrylonitrile-butadiene-styrene (ABS).

FIG. 5 illustrates a structure of the first support member 110. The first support member 110 and the second support member 120 may basically have the same structure.

Each first support member 110 may include first fastening grooves having predetermined intervals and configured to fasten a plurality of second support members. Likewise, each second support member 120 may include second fastening grooves having predetermined intervals and configured to fasten the plurality of first support members.

In one or more embodiments, the first support member 110 may include a first bending support part 111 formed by folding a part of the first support member 110 so that the side of the second support member 120 is supported. Likewise, the second support member 120 may include a second bending support part 121 formed by folding a part of the second support member 120 so that the side of the first support member 110 is supported. As illustrated in FIG. 5, the first bending support part 111 may be formed by folding a part of the first fastening groove 90 degrees. Likewise, the second bending support part 121 may be formed by folding a part of the second fastening groove 90 degrees. In one or more embodiments, as illustrated in FIG. 6, when the first support member 110 and the second support member 120 are cross-fastened, shapes of the first support member 110 and the second support member 120 can be retained without a collapse of the lattice structure because the first support member 110 and the second support member 120 are supporting each other by the first bending support part 111 and the second bending support part 121. Furthermore, in one or more embodiments, as illustrated in FIG. 7, the first bending support part 111 and the second bending support part 121 may support the side of the second support member 120 and the side of the first support member 110, respectively, in a form in which the first bending support part 111 and the second bending support part 121 face each other so that the fire extinguishing structure 100 can be self-supported.

In one or more embodiments, each first support member 110 may include a first bending shape retention part 112 formed by folding the first support member 110 in the length direction of the first support member 110 so that the shape of the first support member 110 is retained. Likewise, the second support member 120 may include a second bending shape retention part 122 formed by folding the second support member 120 in the length direction of the second support member 120 so that the shape of the second support member 120 is retained. Each first support member 110 and each second support member 120 may retain a straight line where each of the first support member 110 and the second support member 120 is viewed from the top (as oriented) after each of the first support member 110 and the second support member 120 is folded in the length direction thereof more than once as described above. Accordingly, an automorphic force of each of the first support member 110 and the second support member 120 can be secured. As illustrated in FIG. 8, the first bending shape retention part 112 may be disposed in the space in which the second bending support part 121 has been folded, and the second bending shape retention part 122 may be disposed in the space in which the first bending support part 111 has been folded.

The fire extinguishing patch 130 may be provided on at least some (e.g., at least one) of the plurality of first support members 110 or the plurality of second support members 120. The fire extinguishing patch 130 may be attached around the area where a fire is expected, in a patch form and can extinguish a fire by using a fire extinguishing medium that is secreted from the fire extinguishing patch, by responding to heat attributable to the fire when the fire occurs. The fire extinguishing patch 130 may be attached to release paper, may then be stripped off from the release paper, and may be attached to at least a part of the first support member 110 or the second support member 120. In one or more embodiments, the fire extinguishing patch 130 may be provided to be adjacent to an intersecting point of the first support member 110 and the second support member 120 and may be disposed at the top of each battery cell 1. Accordingly, when a fire occurs, the fire extinguishing patch 130 can effectively extinguish the fire because the fire extinguishing medium is immediately secreted toward the top of the battery cell 1 in which the fire occurred.

According to one or more embodiments of the present disclosure, a fire that occurs within a battery cell can be effectively extinguished because the fire extinguishing structure that is cross-fastened to form the lattice structure is disposed on a plurality of cells.

According to one or more embodiments of the present disclosure, a cost for manufacturing a battery pack can be reduced because the fire extinguishing patch is disposed by using the fire extinguishing structure that is manufactured, by using a cheap (inexpensive) material without using a separate injection or holder.

According to one or more embodiments of the present disclosure, fire extinguishing performance can be maximized because the fire extinguishing patch having the lattice structure is stably disposed on each battery cell.

FIG. 9 is a flowchart for describing a method of manufacturing a fire extinguishing structure according to one or more embodiments of the present disclosure.

As illustrated in FIG. 9, the method of manufacturing a fire extinguishing structure according to one or more embodiments of the present disclosure may include steps S210, S220, and S230.

Step S210 may be a step of manufacturing the plurality of first support members. In embodiments, step S210 may include a step of forming the first fastening grooves at predetermined intervals and configured to fasten the plurality of second support members. In one or more other embodiments, step S210 may include a step of forming the first bending support part by folding a part of the first support member so that the side of the second support member is supported. Furthermore, in one or more embodiments, step S210 may include a step of forming the first bending shape retention part by folding the first support member in the length direction of the first support member so that a shape of the first support member is retained.

Step S220 may be a step of manufacturing the plurality of second support members. In one or more embodiments, step S220 may include a step of forming the second fastening grooves at predetermined intervals and configured to fasten the plurality of first support members. In one or more other embodiments, step S220 may include a step of forming the second bending support part formed by folding a part of the second support member so that the side of the first support member is supported. Furthermore, in one or more embodiments, step S220 may include a step of forming the second bending shape retention part by folding the second support member in the length direction of the second support member so that a shape of the second support member is retained.

Step S230 may be a step of forming the lattice structure by cross-fastening the plurality of first support members and the plurality of second support members.

The method of manufacturing a fire extinguishing structure according to embodiments of the present disclosure has been described with reference to the flowchart presented in the drawings. For a simple description, the method has been illustrated and described as a series of blocks, but the present disclosure is not limited to the sequence of the blocks, and some blocks may be performed in a sequence different from that of or simultaneously with that of other blocks, which has been illustrated and described in this specification. Various other branches, flow paths, and sequences of blocks which achieve the same or similar results may be implemented. Furthermore, all the blocks illustrated in order to implement the method described in this specification may not be required.

In the description given with reference to FIG. 9, each of the steps may be further divided into additional steps or the steps may be combined into smaller steps depending on an implementation example of the present disclosure. Furthermore, some of the steps may be omitted, if necessary, and the sequence of the steps may be changed. Furthermore, although some contents are omitted, the contents of FIGS. 1A to 8 may be applied to the contents of FIG. 9. Furthermore, although some contents are omitted, the contents of FIG. 9 may be applied to the contents of FIGS. 1A to 8.

Hereinafter, materials which may be used in a secondary battery according to an embodiment of the present disclosure are described.

A compound (e.g., a lithiated intercalation compound) capable of reversible intercalation and deintercalation of lithium may be used as a positive electrode active material. Specifically, one or more types selected among complex oxides of metal, selected among cobalt, manganese, nickel, and a combination of them, and lithium may be used as the positive electrode active material.

The complex oxide may be lithium transition metal complex oxide. A detailed example of the complex oxide may include lithium nickel-based oxide, lithium cobalt-based oxide, lithium manganese-based oxide, a lithium ferrous phosphate-based compound, cobalt-free nickel-manganese-based oxide, or a combination of them.

For example, a compound that is represented as one of the following chemical formulas may be used. LiₐA_{1-b}X_{b}O_{2-c}D_{c}(0.90≤a≤1.8, 0b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤≤0.5, 0≤d<0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiaMn₂G_{b}O₄(0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the chemical formula, A may be Ni, Co, Mn, or a combination of them. X may be Al, Ni, Co, Mn, Cr, Fe, Mg, Sr, V, a rare earth element, or a combination of them; D may be O, F, S, P, or a combination of them. G may be Al, Cr, Mn, Fe, Mg, La, Ce, Sr, V, or a combination of them. L¹ may be Mn, Al, or a combination of them.

A positive electrode for a lithium secondary battery may include a current collector and a positive electrode active material layer formed on the current collector. The positive electrode active material layer may include the positive electrode active material, and may further include a binder and/or a conductive material.

Content of the positive electrode active material may be 90 wt. % to 99.5 wt. % with respect to the positive electrode active material layer 100 wt. %. Content of the binder and the conductive material may be 0.5 wt. % to 5 wt. % with respect to the positive electrode active material layer 100 wt. %.

Al may be used as the current collector, but the present disclosure is not be limited thereto.

A negative electrode active material may include a material capable of reversibly intercalation/de-intercalation with respect to lithium ions, lithium metal, an alloy of lithium metal, a material capable of doping and dedoping with respect to lithium, or transition metal oxide.

The material capable of reversibly intercalation/de-intercalation with respect to lithium ions may include a carbon-based negative electrode active material, for example, crystalline carbon, amorphous carbon, or a combination of them. An example of the crystalline carbon may include graphite, such as natural graphite or synthetic graphite. Examples of the amorphous carbon may include soft or hard carbon, mesophase pitch carbide, and fired coke.

A Si-based negative electrode active material or a Sn-based negative electrode active material may be used as the material capable of doping and dedoping with respect to lithium. The Si-based negative electrode active material may be silicon, a silicon-carbon composite, SiOₓ(0<x<2), a Si-based alloy, or a combination of them.

The silicon-carbon composite may be a composite of silicon and amorphous carbon. According to an implementation example, the silicon-carbon composite may include silicon particles, and may have a form in which amorphous carbon has been coated on surfaces of silicon particles.

The silicon-carbon composite may further include crystalline carbon. For example, the silicon-carbon composite may include a core including crystalline carbon and silicon particles, and an amorphous carbon coating layer disposed on a surface of the core.

A negative electrode for a lithium secondary battery may include a current collector and a negative electrode active material layer disposed on the current collector. The negative electrode active material layer may include the negative electrode active material, and may further include a binder and/or a conductive material.

For example, the negative electrode active material layer may include the negative electrode active material of 90 wt. % to 99 wt. % based on 100 wt. % of the negative electrode active material, the binder of 0.5 wt. % to 5 wt. %, and the conductive material of 0 wt. % to 5 wt. %.

A nonaqueous-based binder, an aqueous-based binder, a dry binder, or a combination thereof may be used as the binder. If the aqueous-based binder is used as a binder for the negative electrode, the binder for the negative electrode may further include a cellulose-series compound capable of assigning viscosity.

One selected among nickel foil, stainless steel foil, titanium foil, nickel foam, copper foam, a polymer base on which a conductive metal has been coated, and a combination of them may be used as a current collector for the negative electrode.

An electrolyte for a lithium secondary battery may include a nonaqueous organic solvent and lithium salts.

The nonaqueous organic solvent may play a role as a medium through which ions that are involved in an electrochemical reaction of a battery can move.

The nonaqueous organic solvent may be a carbonate-based, ester-based, ether-based, ketone-based, or alcohol-based solvent, an aprotic solvent, or a combination of them. The carbonate-based, ester-based, ether-based, ketone-based, or alcohol-based solvent, or the aprotic solvent may be used solely, or two types or more of them may be mixed and used as the nonaqueous organic solvent.

Furthermore, if the carbonate-based solvent is used, annular carbonate and chain carbonate may be mixed and used.

A separator may be present between the positive electrode and the negative electrode depending on the type of lithium secondary battery. Polyethylene, polypropylene, and polyvinylidene fluoride, or a multi-layer having two or more layers of them may be used as the separator.

The separator may include a porous base, and a coating layer including an organic matter, an inorganic matter, or a combination of them that is disposed on one or both sides of the porous base.

The organic matter may include a polyvinylidene fluoride-based heavy antibody or (meth)acrylic polymer.

The inorganic matter may include inorganic particles selected among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination of them, but the present disclosure is not limited thereto.

The organic matter and the inorganic matter may have a form in which the organic matter and the inorganic matter have been mixed in one coating layer or a form in which a coating layer including the organic matter and a coating layer including the inorganic matter have been stacked.

According to one or more embodiments of the present disclosure, a fire occurring within a battery cell can be effectively extinguished because the fire extinguishing structure that is cross-fastened to form a lattice structure is disposed on a plurality of cells.

According to one or more embodiments of the present disclosure, a cost for manufacturing a battery pack can be reduced because the fire extinguishing patch is disposed by using the fire extinguishing structure that is manufactured by using a cheap (inexpensive) material without using a separate injection or holder.

According to embodiments of the present disclosure, fire extinguishing performance can be maximized because the fire extinguishing patch having the lattice structure is stably disposed on each battery cell.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### DESCRIPTION OF REFERENCE NUMERALS

100: fire extinguishing structure
110: first support member
111: first bending support part
112: first bending shape retention part
120: second support member
121: second bending support part
122: second bending shape retention part
130: fire extinguishing patch

What is claimed is:

1. A fire extinguishing structure on a plurality of battery cells, the fire extinguishing structure configured to extinguish a fire when the fire occurs in at least one of the plurality of battery cells, the fire extinguishing structure comprising:
a plurality of first support members;
a plurality of second support members cross-fastened to the plurality of first support members, the plurality of first support members and the plurality of second support members together defining a lattice structure; and
a fire extinguishing patch included on at least one of the plurality of first support members or the plurality of second support members.

2. The fire extinguishing structure as claimed in claim 1, wherein each of the plurality of first support members comprises first fastening grooves at predetermined intervals and configured to fasten each of the plurality of second support members.

3. The fire extinguishing structure as claimed in claim 2, wherein each of the plurality of second support members comprises second fastening grooves at predetermined intervals and configured to fasten each of the plurality of first support members.

4. The fire extinguishing structure as claimed in claim 3, wherein each of the plurality of first support members comprises a first bending support part, each first bending support part being a folded portion of each of the plurality of first support members so that a side thereof is supported.

5. The fire extinguishing structure as claimed in claim 4, wherein each of the plurality of second support members comprises a second bending support part, each second bending support part being a folded portion thereof so that a side of each of the plurality of first support members is supported.

6. The fire extinguishing structure as claimed in claim 5, wherein a first bending support part and the second bending support part support the side of each of the plurality of second support members and the side of each of the plurality of first support members, respectively, wherein the first bending support part and the second bending support part face each other.

7. The fire extinguishing structure as claimed in claim 1, wherein each of the plurality of first support members comprises a first bending shape retention part, each first bending shape retention part being a folded portion of each of the plurality of first support members in a length direction thereof so that a shape of each of the plurality of first support members is retained.

8. The fire extinguishing structure as claimed in claim 7, wherein each of the plurality of second support members comprises a second bending shape retention part, each second bending shape retention part being a folded portion of each of the plurality of second support members in a length direction thereof so that a shape of each of the plurality of second support members is retained.

9. A battery pack, comprising:
a plurality of battery cells; and
a fire extinguishing structure on the plurality of battery cells, the fire extinguishing structure configured to extinguish a fire when the fire occurs in at least one of the plurality of battery cells, wherein the fire extinguishing structure comprises:
a plurality of first support members,
a plurality of second support members cross-fastened to the plurality of first support members, the plurality of first support members and the plurality of second support members together defining a lattice structure, and
a fire extinguishing patch included in at least one of the plurality of first support members or the plurality of second support members.

10. The battery pack as claimed in claim 9, wherein each of the plurality of first support members comprises first fastening grooves at predetermined intervals and configured to fasten the plurality of second support members.

11. The battery pack as claimed in claim 10, wherein each of the plurality of second support members comprises second fastening grooves at predetermined intervals and configured to fasten the plurality of first support members.

12. The battery pack as claimed in claim 11, wherein each of the plurality of first support members comprises a first bending support part, each first bending support part being a folded portion of each of the plurality of second support members so that a side of each of the plurality of second support members is supported.

13. The battery pack as claimed in claim 12, wherein each of the plurality of second support members comprises a second bending support part, each second bending support part being a folded portion of each of the plurality of second support members so that a side of each of the plurality of first support members is supported.

14. The battery pack as claimed in claim 13, wherein the first bending support part and the second bending support part support the side of each of the plurality of second support members and the side of each of the plurality of first support members, respectively, wherein the first bending support part and the second bending support part face each other.

15. The battery pack as claimed in claim 9, wherein each of the plurality of first support members comprises a first bending shape retention part, each first bending shape retention part being a folded portion of each of the plurality of first support members in a length direction thereof so that a shape of each of the plurality of first support members is retained.

16. The battery pack as claimed in claim 15, wherein each of the plurality of second support members comprises a second bending shape retention part, each second bending shape retention part being a folded portion of each of the plurality of second support members in a length direction thereof so that a shape of each of the plurality of second support members is retained.

17. A method of manufacturing a fire extinguishing structure on a plurality of battery cells and configured to extinguish a fire when the fire occurs in at least one of the plurality of battery cells, the method comprising:
manufacturing a plurality of first support members;
manufacturing a plurality of second support members; and
forming a lattice structure by cross-fastening the plurality of first support members and the plurality of second support members.

18. The method as claimed in claim 17, wherein:
the manufacturing of the plurality of first support members comprises forming first fastening grooves having predetermined intervals and configured to fasten the plurality of second support members, and
the manufacturing of the plurality of second support members comprises second fastening grooves having predetermined intervals and configured to fasten the plurality of first support members.

19. The method as claimed in claim 17, wherein:
the manufacturing of the plurality of first support members comprises forming a first bending support part by folding a part thereof so that a side of each of the plurality of second support members is supported, and
the manufacturing of the plurality of second support members comprises forming a second bending support part by folding a part thereof so that a side of each of the plurality of first support members is supported.

20. The method as claimed in claim 17, wherein:
the manufacturing of the plurality of first support members comprises forming a first bending shape retention part by folding each of the plurality of first support members in a length direction thereof so that a shape of each of the plurality of first support members is retained, and
the manufacturing of the plurality of second support members comprises forming a second bending shape retention part by folding each of the plurality of second support members in a length direction thereof so that a shape of each of the plurality of second support members is retained.
